(19) United States
(12) Patent Application Publication
(10) Pub. No.: US 2012/0147159 A1
(43) Pub. Date: Jun. 14, 2012

(54) Three-Dimensional Video System, Shutter Glasses and Wireless Transmission Method

(76) Inventors: Chih-Li Wang, New Taipei City (TW); Ming-Jen Chan, New Taipei City (TW); Yi-Cheng Lee, New Taipei City (TW)

(21) Appl. No.: 13/304,419

(22) Filed: Nov. 25, 2011

(30) Foreign Application Priority Data
Dec. 8, 2010 (TW) 099142805

(51) Int. Cl. H04N 13/04

(52) U.S. Cl. 348/56; 348/E13.04

(57) ABSTRACT

A three-dimensional video system includes a panel driving module, a signal transmitter and a shutter glasses. The panel driving module includes a timing controller, and a control unit, for generating a control signal. The signal transmitter is utilized for transmitting a radio frequency control signal according to the control signal. The shutter glasses includes a receiver, a calibrating and selecting unit, for alternating the receiver between a first operating status and a second operating status, and generating a calibration signal according to the received radio frequency control signal, and an LCD glass, for operating according to the calibration signal.

### BACKGROUND OF THE INVENTION

1. Field of the Invention

The disclosure relates to a three-dimensional video system, shutter glasses and a wireless transmission method, and more particularly, a three-dimensional video system, shutter glasses and a wireless transmission method capable of enhancing synchronicity between video display and shutter glasses operation, and reducing the effect of external interruption or ambience lighting on control signal transmission to the shutter glasses.

2. Description of the Prior Art

Generally, the primary underlying principle for stereoscopy (or three-dimensional imaging), is to present two different images with an offset in visual angle separately to the left and the right eye of the viewer, so as to create the illusion of depth of field and gradation when the viewer's brain superimposes the two offset images and perceives a three-dimensional image.

In the example of the shutter glasses, the viewer's left and right eye can separately see the corresponding images through the left and right LCD glass of the glasses, which can be made to filter light in a controlled, shutter-like motion by alternating the polarization in each LCD glass. In other words, when the right-eye LCD glass is open and the left-eye LCD glass shut, a screen synchronously displays an image for the right eye; similarly, when the left-eye LCD glass is open and the right-eye LCD glass shut, the screen synchronously displays an image for the left eye.

Specifically, please refer to FIG. 1A, which illustrates a three-dimensional video system 10 according to the prior art. The three-dimensional video system 10 includes a video signal generating system 102, an LCD display 104, a signal transmitter 106 and a shutter glasses 108. As shown in FIG. 1A, the video signal generating system 102 utilizes a video processor to process a three-dimensional image to generate a left-eye video signal L with a refresh rate of 60 Hz corresponding to a left-eye video for the left eye and a right-eye video signal R with a refresh rate of 60 Hz corresponding to a right-eye video for the right eye. The left-eye video signal L and the right-eye video signal R are sent to the LCD display 104, then processed and outputted as a video frame alternating between the left-eye video frame and the right-eye video frame with a refresh rate of 120 Hz according to the left-eye video signal L and the right-eye video signal R.

Additionally, please refer to FIG. 1B, which illustrates the signal transmitter 106 and the shutter glasses 108 in FIG. 1A transmitting and receiving signals. The signal transmitter 106 transmits an infrared control signal IR, in the form of infrared, to the shutter glasses 108 according to the 60 Hz refresh rate of the left-eye video signal L or the right-eye video signal R, making the shutter glasses 108 alternately open and shut its left and right LCD glass at a rate of 60 Hz. As a result, when the shutter glasses 108 and LCD display 104 have matching frequencies, the LCD display 104 outputs the corresponding right-eye video frame when the right eye LCD glass of the shutter glasses 108 is opened and the left eye LCD glass is shut, and outputs the corresponding left-eye video frame when the left eye LCD glass of the shutter glasses 108 is open and the right eye LCD glass is shut. Thus, the viewer is able to see the ideal three-dimensional video.

However, it is possible that the LCD display 104 and shutter glasses 108 are out of sync due to signal delay. For example, since a signal source of both the LCD display 104 and the shutter glasses 108 is the video signal generation system 102, when the LCD display 104 processes and outputs the resulting video alternating between the left-eye video and the right-eye video at the 120 Hz refresh rate according to the left-eye video signal L and right-eye video signal R, or when the shutter glasses 108 opens and shuts its left and right LCD glasses alternately at 60 Hz after receiving the control signal IR, signal delays in video processing may cause a break in synchronicity, resulting in the viewer's left eye partially seeing the video corresponding to the right eye, or vice versa, also known as the “crosstalk” effect, which affects the viewing quality of the three-dimensional video. Furthermore, shutter glasses depending on infrared control signals are susceptible to the effects of external interruption and ambience lighting, causing signal transmission to break off. Hence, it is necessary to improve over the technique in the prior art.

### SUMMARY OF THE INVENTION

Therefore, the primary objective of the disclosure is to provide a three-dimensional video system, shutter glasses and wireless transmission method capable of enhancing the synchronicity between the video display and shutter glasses operation, and eliminating the effects of external obstruction and ambience lighting on the transmission of the control signal to the shutter glasses.

The disclosure discloses a three-dimensional video system. The three-dimensional video system includes a panel driving module, a signal transmitter and a shutter glasses. The panel driving module includes a timing controller, for generating a timing signal of a first frequency, the timing signal corresponding to a left-eye video signal and a right-eye video signal; and a control unit, coupled to the timing controller, for generating a control signal of a second frequency according to the timing signal. The signal transmitter, coupled to the control unit, is utilized for generating a radio frequency control signal of a second frequency according to the control signal. The shutter glasses includes a receiver, for receiving the radio frequency control signal, the receiver having a first operating status and a second operating status, wherein the first operating status corresponds to receiving the radio frequency control signal and the second operating status corresponds to stop receiving the radio frequency control signal; a calibrating and selecting unit, coupled to the receiver, the calibrating and selecting unit for alternating the receiver between the first operating status and the second operating status, and generating a calibration signal with a period according to the received radio frequency control signal; and an LCD glass, coupled to the calibrating and selecting unit, the LCD glass for operating according to the period of the calibration signal.

The disclosure further discloses a shutter glasses. The shutter glasses includes a receiver, for receiving a radio frequency control signal, the receiver having a first operating status and a second operating status, wherein the first operating status corresponds to receiving the radio frequency control signal and the second operating status corresponds to stop receiving the radio frequency control signal; a calibrating and selecting unit, coupled to the receiver, the calibrating and selecting unit for alternating the receiver between the first operating status and the second operating status, and generating a calibration signal with a period according to the received radio frequency control signal; and an LCD glass, coupled to the calibrating and selecting unit, the LCD glass for operating according to the period of the calibration signal.

The disclosure further discloses a wireless transmission method for a shutter glasses. The wireless transmission method includes steps of receiving a radio frequency control signal, the reception having a first operating status or second operating status, the first operating status corresponds to receiving the radio frequency control signal, and the second operating status corresponds to stop receiving the radio frequency control signal; alternating between the first operating status and the second operating status, and generating a calibration signal of a period according to the received radio frequency control signal; and operating the LCD glass according to the period of the calibration signal.

These and other objectives of the disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a three-dimensional video system according to the prior art.

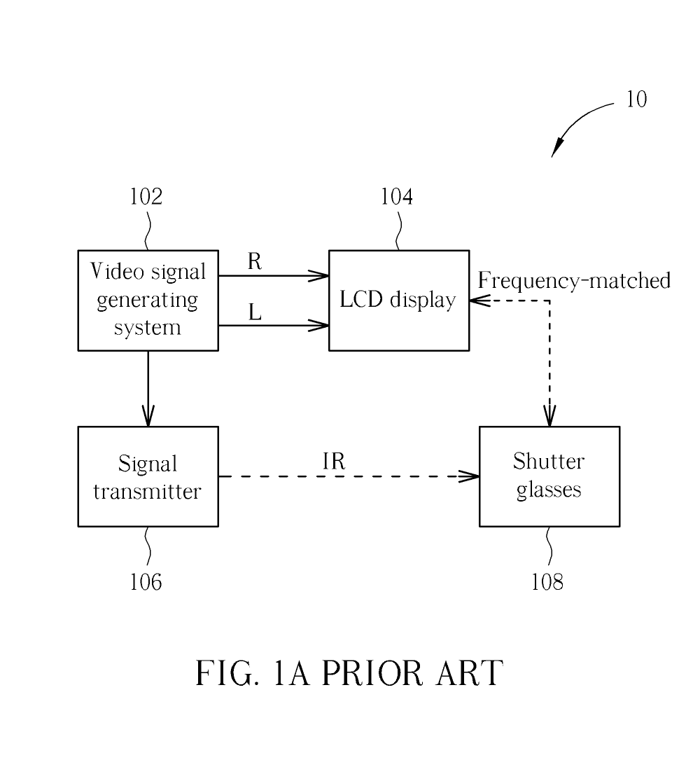

FIG. 1B illustrates a signal transmitter and a shutter glasses in FIG. 1A transmitting and receiving signals.

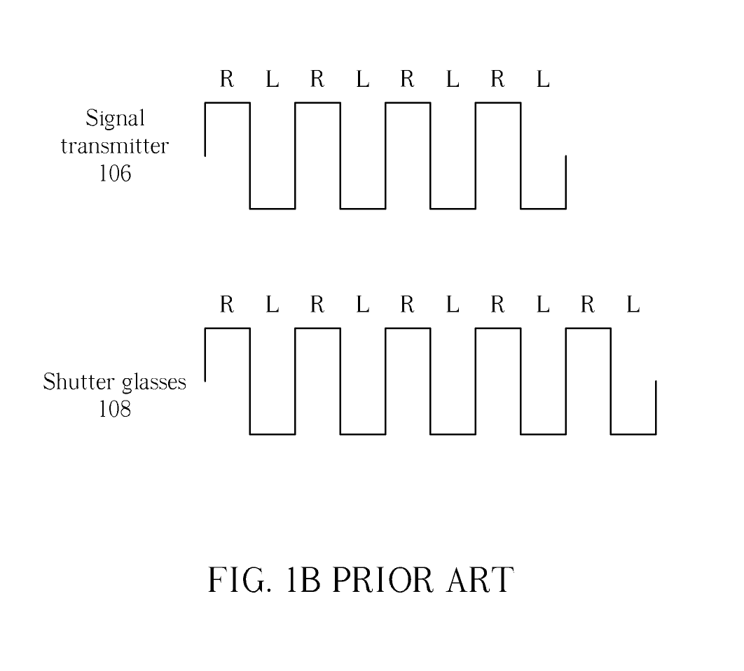

FIG. 2A is an illustration of a three-dimensional video system according to an embodiment of the disclosure.

FIG. 2B is a detailed illustration of a shutter glasses of FIG. 2A according to an embodiment of the disclosure.

FIG. 3A is an illustration of a receiver in FIG. 2A operating in two operating statuses according to an embodiment of the disclosure.

FIG. 3B is an illustration of a calibrating and selecting unit in FIG. 2A generating a calibration signal according to an embodiment of the disclosure.

FIG. 4 is a flowchart of a wireless transmission process according to an embodiment of the disclosure.

### DETAILED DESCRIPTION

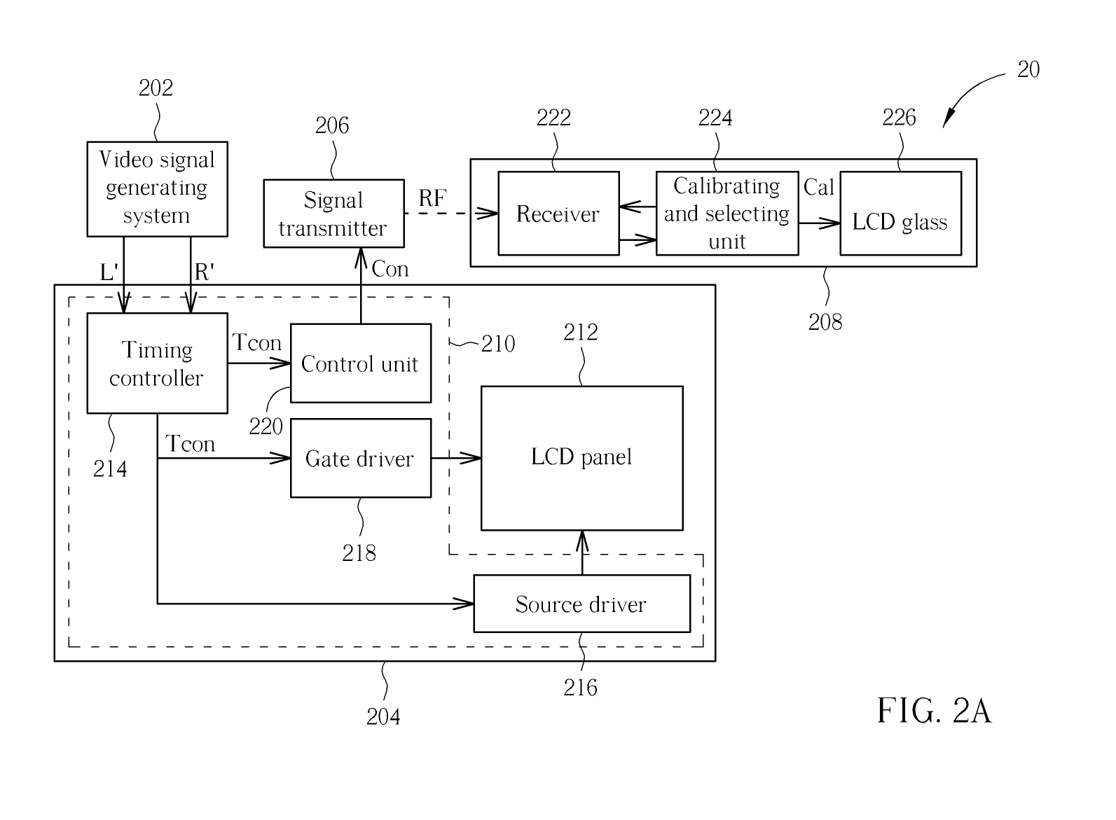

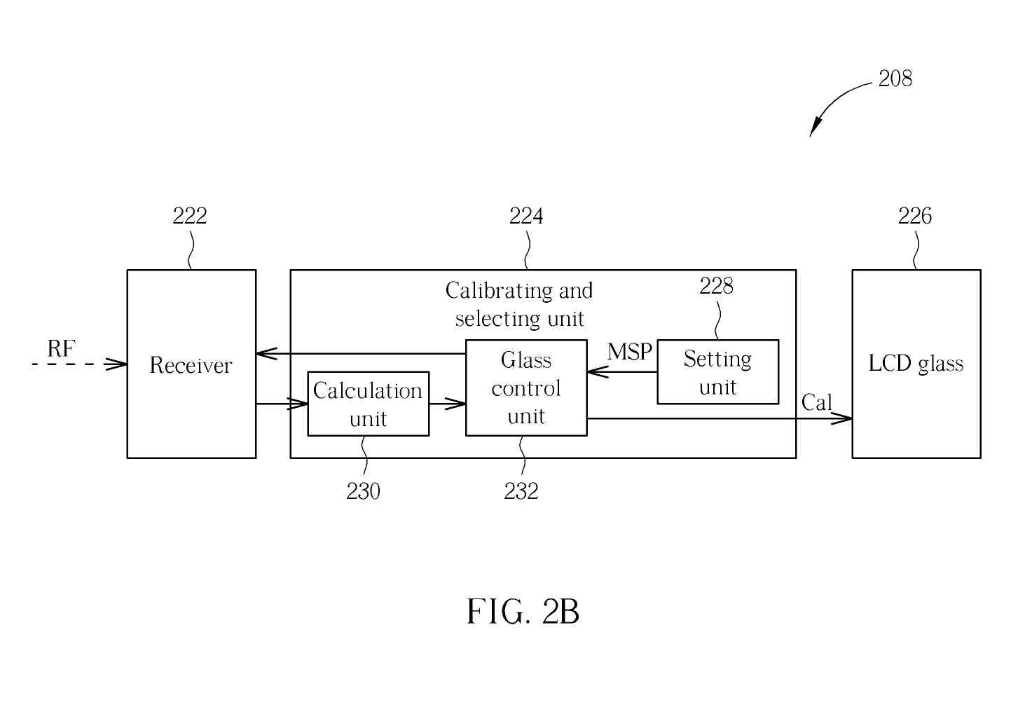

Please refer to FIG. 2A, which is an illustration of a three-dimensional video system 20 of the embodiment of the disclosure. The three-dimensional video system 20 includes a video signal generating system 202, an LCD display 204, a signal transmitter 206 and a shutter glasses 208. The video signal generating system 202 utilizes a video processor to process a three-dimensional video to generate a left-eye video signal L′ with a frequency F1 (e.g. 60 Hz) corresponding to a left-eye video display and a right-eye video signal R′ with a the frequency F1 corresponding to a right-eye video display and send the left-eye video signal L′ and the right-eye video signal R′ to LCD display 204. For instance, the video signal generating system 202 may be a computer system, a digital media playing system, a TV setup box, a network video player, a TV system, or other kinds of multimedia generating devices, but the video signal generating system 202 is not limited thereto.

The LCD display 204 includes a panel driving module 210 and an LCD panel 212. The panel driving module 210 includes a timing controller 214, a source driver 216 and a gate driver 218. After processing the left-eye video signal L′ and the right-eye video signal R′, the timing controller 214 generates a timing signal Tcon with a frequency F2 (e.g. 120 Hz) corresponding to the left-eye video signal L′ and the right-eye video signal R′, to control the source driver 216 and the gate driver 218 to drive the LCD panel 212, such that the LCD panel 212 alternates display at the frequency F2 between the left eye frame of the left-eye video signal L′ and the right-eye frame of the right-eye video signal R′. The above-mentioned LCD display 204 is similar in operation to the LCD display 104.

What sets LCD display 204 apart from LCD display 104 lies in that the panel driving module 210 further includes a control unit 220, for generating a control signal Con with the frequency F1 according to the timing signal Tcon, such that the signal transmitter 206 can transmit, in the form of radio frequency, a radio frequency control signal RF with the frequency F1 according to the control signal Con with the frequency F1 to shutter glasses 208. The shutter glasses 208 includes a receiver 222, a calibrating and selecting unit 224 and an LCD glass 226. The receiver 222 receives the radio frequency control signal RF, and has operating statuses OP1 and OP2. The receiver 222 receives the radio frequency control signal RF in the operating status OP1 and stops receiving the radio frequency control signal RF in the operating status OP2, i.e. the receiver 222 can receive the radio frequency control signal RF in a discontinuous manner to reduce power consumption, a common issue for receiving radio frequency signals. For instance, the signal transmitter 206 and the receiver 222 may adopt any communication protocol among 2.4G, 5.8G, DECT, or other kinds of the radio frequency communication protocol, but the signal transmitter 206 and the receiver 222 are not limited thereto. In practical the signal transmitter 206 and the receiver 222 applications, a low power consumption transmitter is most preferable, such as anyone of spread-spectrum communication technique, UWB, Bluetooth, Wi-Fi, NFC, RFID, and ZigBee, but the signal transmitter 206 and the receiver 222 are not limited thereto.

The calibrating and selecting unit 224 alternates the receiver 222 between the operating statuses OP1 and OP2, and generates a calibration signal Cal with a period P_{Cal} according to the received radio frequency control signal RF, such that the LCD glass 226 can alternately open and shut the left-eye glass and the right-eye glass of the LCD glass 226 according to the period P_{Cal} of the calibration signal Cal, i.e. to change the polarization in LCD glass 226 so as to filter the light passing through it in a shutter-like motion.

Specifically, please refer to FIG. 2B, which is a detailed illustration of the shutter glasses 208 of FIG. 2A according to an embodiment of the disclosure. As shown in FIG. 2B, the calibrating and selecting unit 224 further includes a setting unit 228, a calculation unit 230 and a glass control unit 232. The setting unit 228 sets a main sampling period MSP, wherein the main sampling period MSP includes sampling periods SP1 and SP2. The calculation unit 230 calculates a period P_{RF} of the radio frequency control signal RF received by the receiver 222, and generates the calibration signal Cal. The glass control unit 232 decides the receiver 222 to operate in the operating status OP1 or OP2 according to the sampling periods SP1 and SP2 of the main sampling period MSP, and operates the LCD glass 226 according to the period P_{Cal} of the calibration signal Cal.

In more detail, the glass control unit 232 controls the receiver 222 to operate in the operating status OP1 during the sampling period SP1, in which the receiver 222 receives the radio frequency control signal RF, and operate in the operating status OP2 during the sampling period SP2, in which the receiver 222 stops receiving the radio frequency control signal RF. Thus, after the shutter glasses 208 is powered on, the glass control unit 232 first activates the receiver 222 during the sampling period SP1 to receive the radio frequency control signal RF, then stops the receiver 222 during the sampling period SP2 to stop receiving the radio frequency control signal RF. In such a situation, when the receiver 222 is in the operating status OP1 and receives the radio frequency control signal RF, the calculation unit 230 generates the calibration signal Cal according to the period P_{RF} of the currently received the radio frequency control signal RF; and when the receiver 222 is in the operating status OP2 and stops receiving the radio frequency control signal RF, the calculation unit 230 generates the calibration signal Cal according to the period P_{RF} of the radio frequency control signal RF received in a previous the operating status OP1. As a result, the receiver 222 can receive the radio frequency control signal RF discontinuously to conserve power, since power consumption is a common issue for receiving radio frequency signals.

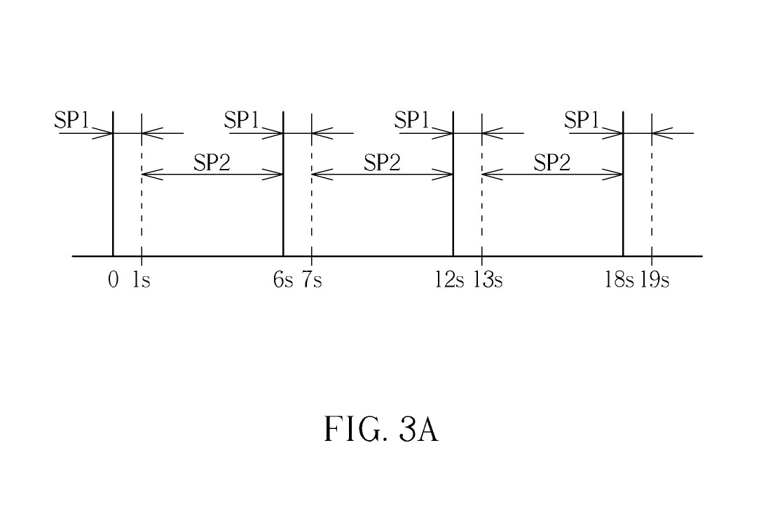

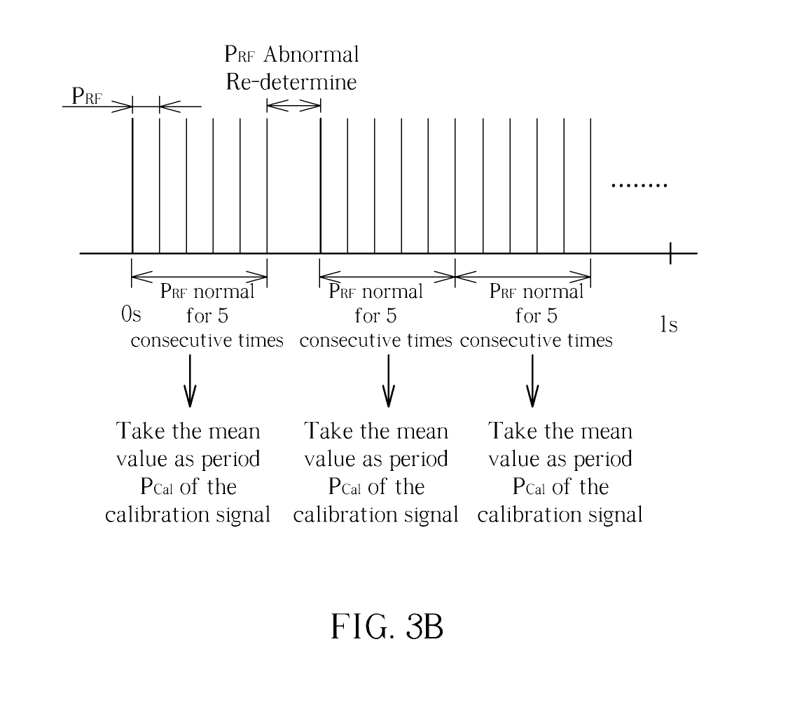

In this embodiment, please refer to FIG. 3A, which is an illustration of the receiver 222 in FIG. 2A operating in the first and the second the operating statuses OP1 and OP2 according to an embodiment of the disclosure. In FIG. 3A, the setting unit 228 sets the sampling period SP1 not shorter than 0.1 seconds and not longer than 5 seconds, and the sampling period SP2 not shorter than 3 seconds and not longer than 15 seconds, e.g. the sampling period SP1 is 1 second and the sampling period SP2 is 5 seconds, but not limited thereto; therefore after the shutter glasses 208 is powered on, the glass control unit 232 controls the receiver 222 to receive the radio frequency control signal RF for 1 second, then stop receiving the radio frequency control signal RF for 5 seconds, i.e. during 0˜1 seconds, 6˜7 seconds, 12˜13 seconds and 18˜19 seconds the receiver 222 receives the radio frequency control signal RF. As a result, the receiver 222 can utilize a discontinuous reception to receive the radio frequency control signal RF to conserve power, which is a common issue for receiving radio frequency signals. Noticeably, the above-mentioned sampling periods SP1 and SP2 set by the setting unit 228 merely pertain to an embodiment of the disclosure, and one with ordinary skills in the art may make alterations and modifications accordingly, e.g. setting a sampling period SP1 of 4 seconds and a sampling period SP2 of 14 seconds.

Furthermore, after the shutter glasses 208 is powered on, if the receiver 222 does not receive the radio frequency control signal RF during the sampling period MSP for a specific number of times, or if the receiver 222 does not receive the radio frequency control signal RF for a specified time duration, the shutter glasses 208 can be turned off to conserve power, wherein the specific number is not smaller than 2 and the specified time duration not shorter than 5 seconds, e.g. the specific number is 2 and the specified time duration is 12 seconds, but not limited thereto. Thus the receiver 222 alternates between the sampling period SP1 and SP2, and during the operating status OP1 (receiving the radio frequency control signal RF) of the sampling period SP1, if the receiver 222 does not receive the radio frequency control signal RF for 2 consecutive times, the shutter glasses 208 is powered off to conserve power. In other words, after the shutter glasses 208 is powered on, if the receiver 222 does not receive the radio frequency control signal RF for up to 12 seconds, the shutter glasses 208 can also be powered off to conserve power.

In this embodiment, please refer to FIG. 3B for an illustration of the calibrating and selecting unit 224 in FIG. 2A generating the calibration signal Cal according to an embodiment of the disclosure. When the receiver 222 operates in the first the operating status OP1 and receives the radio frequency control signal RF, the calibrating and selecting unit 224 generates the calibration signal Cal according to the period P_{RF} of the received radio frequency control signal RF. As illustrated in FIG. 3B, in an aforementioned first sampling period SP1 (e.g. 0˜1 sec), the calibrating and selecting unit 224 can determine the value of the period P_{RF} of the received radio frequency control signal RF, to be normal when an absolute difference between the period P_{RF} of the received radio frequency control signal RF and a period P_{con} of the control signal Con, is less than or equal to a specific value. The calibrating and selecting unit 224 can take a mean value of these consecutive P_{RF} as a period P_{cal} of the calibration signal Cal after determining normal values for the periods P_{RF} of the radio frequency control signals for a specified number of consecutive times, wherein the specified number of the consecutive times is no smaller than 3, e.g. 5 times, but not limited thereto.

The calibrating and selecting unit 224 can determine the period P_{RF} of the received radio frequency control signal RF to be abnormal when the absolute difference between the period P_{RF} of the radio frequency control signal and the period P_{con} of the control signal Con, is greater than a specific value. The calibrating and selecting unit 224, after determining an abnormal value for the period P_{RF} of the radio frequency control signal, would measure the period P_{RF} of the radio frequency control signal RF, for another 5 consecutive times and determine if the 5 consecutive values of P_{RF} are all normal. As for in an aforementioned second sampling period SP2, (e.g. 1˜6 sec), the calibrating and selecting unit 224 continues to generate the calibration signal Cal according to the P_{RF}, period of the radio frequency control signal, received during the previous first the operating status OP1 (i.e. 0˜1 sec). As a result, the calibrating and selecting unit 224 can, according to P_{Cal}, the period of the calibration signal Cal, stably operate the LCD glass 226 to alternately open and shut the left-eye and right-eye glass, enhancing the synchronicity between the operation of the LCD glass 226 and the video display of the LCD panel 212.

It is worth noting that the aforementioned specific value may be one greater than 3% of P_{con}, the period of the control signal Con, e.g. 5% of P_{con}, but not limited thereto. In this embodiment, if the period of the control signal Con, P_{con} is 16.67 ms, then 5% of P_{con} would be 0.83 ms, and the calibrating and selecting unit 224 can determine normal value if P_{RF}, the period of the radio frequency control signal RF, is greater than or equal to 15.84 ms and smaller than or equal to 17.5 ms, and conversely determine abnormal value if P_{RF} is smaller than 15.84 ms or greater than 17.5 ms. When the calibrating and selecting unit 224 has determined normal value for P_{RF}, the period of the radio frequency control signal RF for 5 consecutive times, it would take the mean value of the 5 as P_{Cal}, the period of the calibration signal Cal, and operate the LCD glass 226 accordingly. The aforementioned specific value merely pertains to an embodiment of the disclosure and those with ordinary knowledge in the art may make modifications and alterations accordingly, e.g. 8% of P_{con} as the specific value.

As can be seen from the above, the control unit 220 can generate the control signal Con with the frequency F1 of the original left-eye video signal L′ and the right-eye video signal R′ from the timing signal Tcon with the frequency F2 corresponding to the left-eye video signal L′ and the right-eye video signal R′. The control unit 220 then sends the control signal Con to the signal transmitter 206, for the signal transmitter 206 to transmit the radio frequency control signal RF to control the shutter glasses 208 to alternate between opening and shutting the left eye glass and the right eye glass of the LCD glass 226, i.e. by changing the polarization of the LCD glass 226 to filter light in a shutter-like motion. In such a situation, the LCD glass 226 alternates between opening and closing the left glass and the right eye glass, for the LCD panel 212 to present the left-eye video frame and the right-eye video frame separately to the viewer's left eye or right eye. As a result, the viewer's left eye and right eye alternately see the respective frame from the LCD panel 212 meant for each eye, and the viewer's brain superimposes the two video frames to perceive a three-dimensional image through the effect persistence of vision.

In other words, when the LCD panel 212 is displaying video for the right eye, the LCD glass 226 synchronously controls the right eye glass to open and the left eye glass to shut according to the radio frequency control signal RF, enabling the right eye to see the right eye video frame and disenabling the left eye from seeing the same; conversely, when LCD panel 212 is displaying video frame for the left eye, LCD glass 226 synchronously controls the left eye glass to open and the right eyeglass to shut according to the radio frequency control signal RF, enabling the left eye to see and disenabling the right eye from doing the same. Thus, the viewer is able to see the ideal three-dimensional video.

As a result, the LCD panel 212, which alternates between displaying the left-eye video frame and the right-eye video frame, is controlled by the source driver 216 and the gate driver 218 according to the timing signal Tcon; and the radio frequency control signal RF, which controls the alternating operation of the LCD glass 226, is also generated according to the timing signal Tcon of the control unit 220 corresponding to the left-eye video signal L′ and the right-eye video signal R′. In such a situation, both the LCD panel 212 and the LCD glass 226 operate according to the processed timing signal Tcon, thus enhancing the synchronicity between the LCD glass 226 and the LCD panel 212 and eliminating the crosstalk effect; furthermore, the disclosure utilizes radio frequency as the means of transmission for the radio frequency control signal RF, thus reducing the effect of external interruption or ambience lighting on signal transmission, and also allowing the utilization of frequency-hopping spread spectrum techniques to switch between two or more channels in case of excessive external interference.

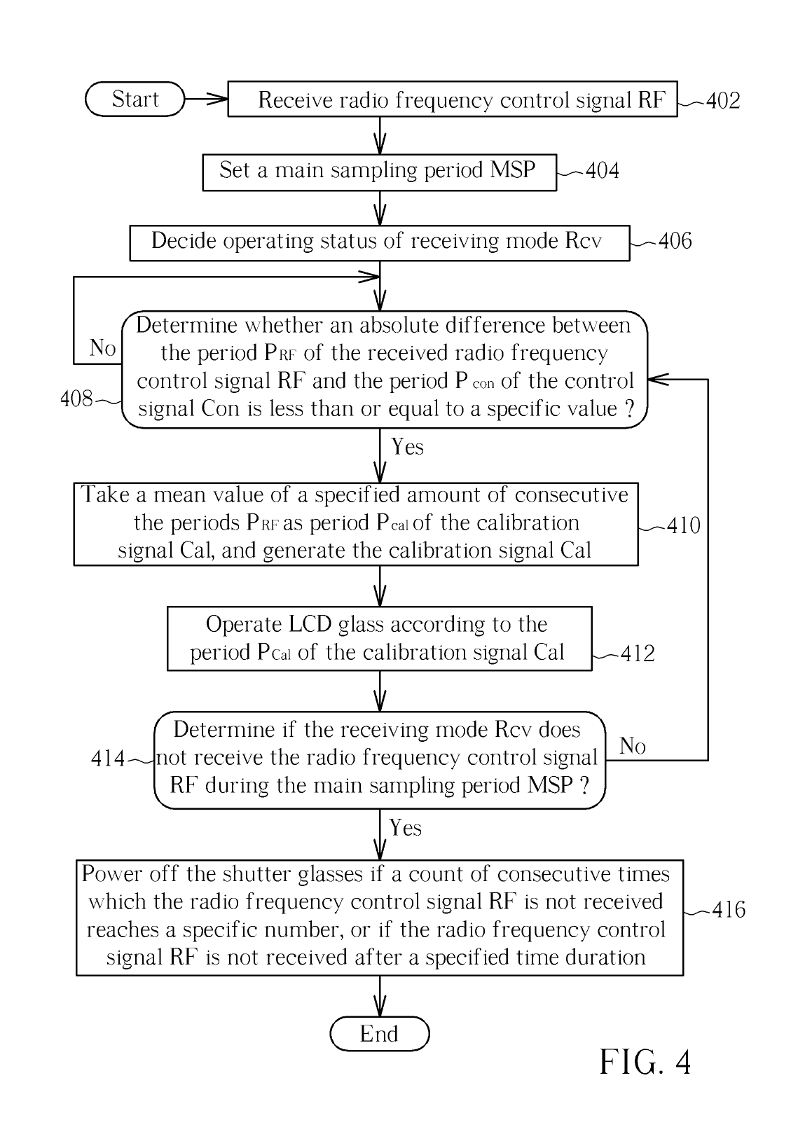

After the shutter glasses 208 is powered on, the operation can be described by a wireless transmission process 40, as illustrated by the flowchart of FIG. 4. The wireless transmission procedure 4 includes the following steps:

step 402: Receive the radio frequency control signal RF.

The receiving mode Rcv has the operating status OP1 or the operating status OP2, wherein the operating status OP1 corresponds to receiving the radio frequency control signal RF, and the operating status OP2 corresponds to stop receiving the radio frequency control signal RF.

step 404: Set a main sampling period MSP.

The main sampling period MSP includes the sampling periods SP1 and SP2. In this embodiment, the main sampling period is 6 seconds, the sampling period SP1 is 1 second and the sampling period SP2 is 5 seconds, but not limited thereto.

Step 406: Decide the operating status of receiving mode Rcv.

Decide the operating status OP1 during the sampling period SP1 and decide the operating status OP2 during the sampling period SP2. Alternate between the operating status OP1 and the operating status OP2 according to the main sampling period MPS.

Step 408: Determine whether an absolute difference between the period P_{RF} of the received radio frequency control signal RF and the period P_{con} of the control signal Con is less than or equal to a specific value.

Determine the period P_{RF} of the received the radio frequency control signal RF is normal, if the absolute difference between the period P_{RF} of the received radio frequency control signal RF and the period P_{con} of the control signal Con is less than or equal to the specific value; determine the period P_{RF} of the received radio frequency control signal RF is abnormal, if the absolute difference is greater than the specific value. In this embodiment the specific value is 0.83 ms, hence determine the period P_{RF} of the received radio frequency control signal RF is normal if P_{RF} is greater than or equal to 15.84 ms and less than or equal to 17.5 ms; and determine the period P_{RF} of the received radio frequency control signal RF is abnormal if P_{RF} is less than 15.84 ms or greater than 17.5 ms, but the period P_{RF} is not limited thereto. If the result of the step 408 is “true”, go to Step 410; if the result of the step 408 is “false”, repeat the step 408.

Step 410: Take a mean value of a specified amount of consecutive the periods P_{RF} as period P_{cal} of the calibration signal Cal, and generate the calibration signal Cal.

In this embodiment, after determining the period P_{RF} of the received radio frequency control signal RF is normal for 5 consecutive times, take the mean value of the 5 consecutive periods P_{RF} as period P_{cal} of the calibration signal Cal, but the specified amount is not limited thereto.

Step 412: Operate LCD glass 226 according to the period P_{Cal} of the calibration signal Cal.

Step 414: Determine if the receiving mode Rcv does not receive the radio frequency control signal RF during the main sampling period MSP. If the result of the Step 414 is “true”, go to method 416; if the result of Step 414 is “false”, go to Step 408.

Step 416: Power off the shutter glasses 208 if a count of consecutive times which the radio frequency control signal RF is not received reaches a specific number, or if the radio frequency control signal RF is not received after a specified time duration.

In this embodiment, if the radio frequency control signal RF is not received up to 2 times, or not received after 12 seconds, the shutter glasses 208 is powered off, but the specific number and specified time duration are not limited thereto.

It is worth noting the essence of the disclosure lies in that both Tcon, the timing signal for controlling LCD panel 212 to alternate between the left-eye and right-eye video frame, and RF, the radio frequency control signal for controlling the shutter glasses 208 to alternate between opening and shutting the left LCD glass and the right LCD glass, share a common signal source, i.e. the timing signal Tcon processed by the timing controller 214, enhancing synchronicity between the display of the LCD panel 212 and the operation of the shutter glasses 208 and eliminating crosstalk; and that, by using the radio frequency control signal RF one can overcome issues in the prior art, e.g. the effects of external interruption or ambience lighting on signal transmission. Furthermore, the receiver 222 uses discontinuous transmission to receive the radio frequency control signal RF to conserve power usage, which is a common issue for receiving radio frequency signals. Finally, the shutter glasses 208 is powered off if it does not receive the radio frequency control signal RF, further conserving the power usage.

In summary, the disclosure enhances the synchronicity between the LCD panel and shutter glasses operation and eliminates crosstalk, reduces the effect of external interruption or ambience lighting on control signal transmission, and conserves power usage. The aforementioned merely pertains to an embodiment of the disclosure, and any alterations or modifications derived from the disclosure fall within the scope of the disclosure. Those with ordinary skills in the disclosure can make alterations and modifications accordingly and is not limited thereto. For instance, in the aforementioned embodiment, after the shutter glasses 208 is powered on, the glass control unit 232 first activates the receiver 222 to start receiving the radio frequency control signal RF during the sampling period SP1, then stops the receiver 222 to stop receiving the radio frequency control signal RF during the sampling period SP2, but alternatively the glass control unit 232 may first stop the receiver 222 to stop receiving the radio frequency control signal RF during the sampling period SP2, then activate the receiver 222 to start receiving the radio frequency control signal RF the sampling period SP1, but not limited thereto.

Those skilled in the art will readily observe that numerous modifications and alterations of the device and method may be made while retaining the teachings of the disclosure.

What is claimed is:

1. A three-dimensional video system, comprising:
a panel driving module, comprising:
a timing controller, for generating a timing signal of a first frequency, the timing signal corresponding to a left-eye video signal and a right-eye video signal; and
a control unit, coupled to the timing controller, for generating a control signal of a second frequency according to the timing signal;
a signal transmitter, coupled to the control unit, for transmitting a radio frequency control signal of the second frequency according to the control signal; and
a shutter glasses, comprising:
a receiver, for receiving the radio frequency control signal, the receiver having a first operating status and a second operating status; wherein the receiver receives the radio frequency control signal in the first operating status and stops receiving the radio frequency signal in the second operating status;
a calibrating and selecting unit, coupled to the receiver, for alternating the receiver between the first operating status and the second operating status, and generating a calibration signal of a period according to the received radio frequency control signal; and
an LCD glass, coupled to the calibrating and selecting unit, for operating according to the period of the calibration signal.

2. The three-dimensional video system of claim 1, wherein the calibrating and selecting unit further comprises:
a setting unit, for setting a main sampling period, which comprises a first sampling period and a second sampling period;
a calculation unit, for calculating a period of the radio frequency control signal received by the receiver, and generating the calibration signal; and
a glass control unit, for deciding the receiver to operate in the first operating status or the second operating status according to the main sampling period, and operating the LCD glass according to the period of the calibration signal.

3. The three-dimensional video system of claim 2, wherein the glass control unit controls the receiver to operate in the first operating status during the first sampling period, and operate in the second operating status during the second sampling period.

4. The three-dimensional video system of claim 3, wherein the calculation unit generates the calibration signal according to the period of the radio frequency control signal received in a previous first operation status when the receiver operates in the second operating status.

5. The three-dimensional video system of claim 3, wherein the first sampling period is not shorter than 0.1 seconds and not longer than 5 seconds; and the second sampling period is not shorter than 3 seconds and not longer than 15 seconds.

6. The three-dimensional video system of claim 2, wherein after the shutter glasses is powered on, the shutter glasses is powered off if a count of consecutive times which the receiver does not receive the radio frequency control signal during a main sampling period reaches a specific number, wherein the specific number is not less than 2.

7. The three-dimensional video system of claim 1, wherein the calibrating and selecting unit determines the period of the received radio frequency control signal is normal if an absolute difference between a period of the received radio frequency and a period of the control signal is less than or equal to a specific value; and the calibrating and selecting unit takes a mean value of periods of a specified amount of consecutive radio frequency control signals as the period of the calibration signal, after determining all the periods of the specified consecutive amount of the received radio frequency control signals are normal.

8. The three-dimensional video system of claim 7, wherein the calibrating and selecting unit determines the period of the received radio frequency control signal is abnormal, if the absolute difference between the period of the received radio frequency control signal and the period of the control signal is greater than the specific value; and the calibrating and selecting unit further determines whether all periods of another specified amount of consecutive radio frequency control signals are normal after determining the period of the received radio frequency control signal is abnormal.

9. The three-dimensional video system of claim 8, wherein the specific value is greater than 3% of the period of the control signal; and the specified consecutive amount is not less than 3.

10. The three-dimensional video system of claim 1, wherein after the shutter glasses is powered on, the shutter glasses is powered off if the receiver does not receive the radio frequency control signal after a first time duration, wherein the first time duration is not shorter than 5 seconds.

11. A shutter glasses, comprising:
a receiver, for receiving a radio frequency control signal, the receiver having a first operating status and a second operating status, wherein the receiver receives the radio frequency control signal in the first operating status and stops receiving the radio frequency signal in the second operating status;
a calibrating and selecting unit, coupled to the receiver, for alternating the receiver in the first operating status and the second operating status, and generating a calibration signal of a period according to the received radio frequency control signal; and
an LCD glass, coupled to the calibrating and selecting unit, for operating according to the period of the calibration signal.

12. The shutter glasses of claim 11, wherein the calibrating and selecting unit further comprises:
a setting unit, for setting a main sampling period, which comprises a first sampling period and a second sampling period;
a calculation unit, for calculating a period of the radio frequency control signal received by the receiver, and generating the calibration signal; and
a glass control unit, for deciding the receiver to operate in the first operating status or the second operating status according to the main sampling period, and operating the LCD glass according to the period of the calibration signal.

13. The shutter glasses of claim 12, wherein the glass control unit controls the receiver to operate in the first operating status during the first sampling period, and operate in the second operating status during the second sampling period.

14. The shutter glasses of claim 13, wherein the calculation unit generates the calibration signal according to the period of the radio frequency control signal received in a previous first operating status when the receiver operates in the second operating status.

15. The shutter glasses of claim 13, wherein the first sampling period is not shorter than 0.1 seconds and not longer than 5 seconds; and the second sampling period is not shorter than 3 seconds and not longer than 15 seconds.

16. The shutter glasses of claim 12, wherein after the shutter glasses is powered on, the shutter glasses is powered off if a count of consecutive times which the receiver does not receive the radio frequency control during a main sampling period signal reaches a specific number, wherein the specific number is not less than 2.

17. The shutter glasses of claim 11, wherein the calibrating and selecting unit determines the period of the received radio frequency control signal is normal if an absolute difference between a period of the received radio frequency and a period of the control signal is less than or equal to a specific value; and the calibrating and selecting unit takes a mean value of periods of a specified number of consecutive radio frequency control signals as the period of the calibration signal, after determining all the periods of the specified consecutive amount of the received radio frequency control signals are normal.

18. The shutter glasses of claim 17, wherein the calibrating and selecting unit determines the period of the received radio frequency control signal is abnormal, if the absolute difference between the period of the received radio frequency control signal and the period of the control signal is greater than the specific value; and the calibrating and selecting unit further determines whether all periods of another specified amount of consecutive radio frequency control signals are normal, after determining the period of the received radio frequency is abnormal.

19. The shutter glasses of claim 18, wherein the specific value is greater than 3% of the period of the control signal; and the specified consecutive amount is not less than 3.

20. The shutter glasses of claim 11, wherein after the shutter glasses is powered on, the shutter glasses is powered off if the receiver does not receive the radio frequency control signal after a first time duration, wherein the first time duration is not shorter than 5 seconds.

21. A wireless transmission method for a shutter glasses, the method comprising:
receiving a radio frequency control signal, which is a receiving mode comprising a first operating status and a second operating status, wherein the first operating status corresponds to receiving the radio frequency control signal, and the second operating status corresponds to stop receiving the radio frequency control signal in;
alternating between the first operating status and the second operating status, and generating a calibration signal of a period according to the received radio frequency control signal; and
operating an LCD glass according to the period of the calibration signal.

22. The wireless transmission method of claim 21, wherein the step of selecting the receiving mode comprises:
setting a main sampling period, comprising a first sampling period and a second sampling period;
calculating a period of the radio frequency control signal received by the receiver, and generating the calibration signal; and
deciding the operating status of the receiving mode according to the main sampling period, and operating the LCD glass according to the period of the calibration signal.

23. The wireless transmission method of claim 22, wherein the step of deciding the operating status of the receiving mode further comprises:
deciding the receiving mode is in the first operating status during the first sampling period; and
deciding the receiving mode is in the second operating status during the second sampling period.

24. The wireless transmission method of claim 23, further comprising still calculating the period of the received radio frequency control signal in a previous first operating status when the receiving mode is in the second operating status, to generate the calibration signal.

25. The wireless transmission method of claim 23, wherein the first sampling period is not shorter than 0.1 seconds and not longer than 5 seconds; and the second sampling period is not shorter than 3 seconds and not longer than 15 seconds.

26. The wireless transmission method of claim 22, wherein after the shutter glasses is powered on, the shutter glasses is powered off if a count of consecutive times which the receiving mode does not receive the radio frequency control signal reaches a specific number, wherein the specific number is not less than 2.

27. The wireless transmission method of claim 21, wherein the step of generating the calibration signal comprises:
determining the period of the received radio frequency control signal is normal if an absolute difference between a period of the received radio frequency control signal and a period of the control signal is less than or equal to a specific value; and
taking a mean value of periods of a specified amount of consecutive times of radio frequency control signals as the period of the calibration signal after determining all periods of the specified consecutive amount of the received radio frequency control signals are normal.

28. The wireless transmission method of claim 27, wherein the step of generating the calibration signal further comprises:
determining the period of the received radio frequency control signal is abnormal if the absolute difference between the period of the received radio frequency control signal and the period of the control signal is greater than the specific value; and
further determining whether all periods of another specified amount of consecutive radio frequency control signals are normal after determining the period of the received radio frequency control signal is abnormal.

29. The wireless transmission method of claim 28, wherein the specific value is greater than 3% of the period of the control signal; and the specified amount of consecutive times is not less than 3.

30. The wireless transmission method of claim 21, wherein after the shutter glasses is powered on, the shutter glasses is powered off if the receiving mode does not receive the radio frequency control signal after a first time duration, wherein the first time duration is not shorter than 5 seconds.
